(19) United States
(12) Patent Application Publication
(10) Pub. No.: US 2024/0291070 A1
(43) Pub. Date: Aug. 29, 2024

(54) THERMAL REGULATION DEVICE FOR AT LEAST ONE ELECTRICAL AND/OR ELECTRONIC ELEMENT

(71) Applicant: Valeo Systemes Thermiques, Le Mesnil-Saint-Denis (FR)

(72) Inventors: Jeremy Blandin, Le Mesnil-Saint-Denis (FR); Julien Tissot, Le Mesnil-Saint-Denis (FR); Kamel Azzouz, Le Mesnil-Saint-Denis (FR)

(73) Assignee: Valeo Systemes Thermiques, Le Mesnil-Saint-Denis (FR)

(21) Appl. No.: 18/571,475

(22) PCT Filed: Jun. 10, 2022
(86) PCT No.: PCT/EP2022/065873

§ 371 Date: Dec. 18, 2023

(30) Foreign Application Priority Data
Jun. 17, 2021 (FR) FR2106429

(51) Int. Cl. H01M 10/6568; F28D 1/02; H01M 10/613; H01M 50/204

(52) U.S. Cl. CPC H01M 10/6568; F28D 1/0213; H01M 10/613; H01M 50/204

(57) ABSTRACT

The present invention relates to a thermal regulation device for an electrical or electronic component. The thermal regulation device includes at least one housing. The housing includes a plurality of walls that delimit a receptacle. The receptacle is designed to receive the electrical or electronic component. The device also includes a dielectric fluid circuit configured to permit the circulation of a dielectric fluid. At least one of the walls of the housing includes at least one orifice for spraying dielectric fluid in the receptacle. The spraying orifice is fluidically connected to the dielectric fluid circuit. The circuit includes a section formed within one of the walls of the housing. The section also receives a thermal element that is designed to exchange heat with the dielectric fluid circuit.

The present invention comes within the field of thermal regulation devices for at least one electrical and/or electronic component liable to heat up, and in particular it concerns a thermal regulation device for electronic systems comprising such components.

The electronic systems which the present invention may concern can also consist of computer servers, as well as electrical energy storage systems, in particular battery elements, or also semiconductors, for example for motor vehicles.

In the field of motor vehicles, thermal regulation devices make it possible to modify a temperature of an electrical energy storage system, either during starting of the vehicle in cold weather, by increasing its temperature for example, or during travel, or during an operation of recharging said system, by decreasing the temperature of the battery elements, which tend to heat up when they are being used.

In general, thermal regulation devices of this type of electrical energy storage systems use heat exchangers. The different battery elements of an electrical energy storage system can in particular be cooled by means of a cold plate, in the interior of which a cooling fluid circulates, the plate being in contact with the battery elements to be cooled. It has been found that heat exchangers of this type can lead to irregular cooling of the battery elements of a single electrical energy storage system, thus giving rise to a decrease in the global performance of said system. These thermal regulation devices also have high thermal resistance because of the thicknesses of material present between the cooling fluid and the battery elements.

In addition, the size of such devices is large, since they require sufficient clearance between the heat exchangers and the components, the temperature of which is to be regulated, which involves over-sizing of the housing in which the electrical or electronic components are accommodated.

Data centers around the world currently account for 10% of global electricity consumption. The advent of Blockchain and 5G technologies mean that this percentage could increase drastically in future years. At least half of this consumption comes from the cooling systems of these data centers. At present, most data centers are cooled by air cooling the ambient air of the storage rooms by means of air conditioning devices. The optimal operating temperature for data centers is between 5° C. and 40° C., more particularly approximately 27° C. Taking into consideration the fact that air has very low conductivity, in order to cool the electronic elements sufficiently, bearing in mind that they can reach temperatures in excess of 60° C., the temperature difference between the air and the electronic elements to be cooled must be substantial, and consequently this type of device is highly energy-consuming.

For the purpose of providing a response to these different problems, a plurality of devices are known.

In particular, devices for cooling electric battery elements of electric or hybrid vehicles are known comprising a hermetically sealed housing in which the battery elements of the electrical energy storage system are partly immersed in a dielectric fluid. This therefore assures a thermal exchange between the battery elements and the dielectric fluid, with a dielectric fluid tank being situated on the exterior of the housing, and connected to said housing in order to permit the circulation of the dielectric fluid.

However, the immersion of the electric battery elements in the fluid, which in particular is dielectric, does not permit sufficiently homogeneous cooling of said elements. Document FR3077683 discloses a device for cooling battery elements, which also has a hermetic housing in which a dielectric fluid is placed, but in which the dielectric fluid is sprayed onto the battery elements via a circuit and appropriate spraying means. When in contact with the battery elements that have heated up during their operation, the sprayed dielectric fluid tends to vaporize, and the vapor propagates through the housing and in particular along the walls delimiting the housing. Document FR3077683 discloses the presence of a condensation wall, comprising in its interior a cooling fluid circuit, the wall being a so-called condensation wall since the temperature of this wall makes it possible to condensate the vapor such that the dielectric fluid regains liquid form.

In this case also, in accordance with what has previously been described, a multiple problem of size arises. The means which are necessary in order to permit the circulation then the spraying of the dielectric fluid consist of a plurality of ducts which permit the circulation of the dielectric fluid in the interior of the housing, passing in particular through the walls of the housing in order to permit the entry and exit of the fluid in the thermal regulation device. The assembly can also be complicated as a result of this multiplicity of ducts which must be secured relative to the walls of the housing, so that they do not come into contact with the electrical or electronic components before the fluid is sprayed.

The invention comes within this context, and its objective is to provide an alternative to the known thermal regulation devices, in particular in their application to electrical storage devices such as motor vehicle batteries, which, inter alia, will make it possible to eliminate the aforementioned problems.

In this context, the present invention relates to a thermal regulation device for at least one electrical and/or electronic component, the temperature of which must be regulated, with the thermal regulation device comprising at least one housing comprising a plurality of walls delimiting a receptacle which is designed to receive said electrical and/or electronic component, the device also comprising a dielectric fluid circuit which is configured to permit the circulation of a dielectric fluid, characterized in that at least one of the walls of the housing comprises at least one orifice for spraying of dielectric fluid in the receptacle which is fluidically connected to the dielectric fluid circuit, the dielectric fluid circuit comprising a section formed within one of the walls of the housing, and the section of the dielectric fluid circuit also receives a thermal element which is designed to exchange heat with the dielectric fluid circulating in the dielectric fluid circuit.

By convention, throughout the present document, the term “longitudinal” applies to the direction of a main dimension of the housing of the thermal regulation device connecting two opposite lateral walls, the term “transverse” applies to a direction substantially perpendicular to the longitudinal direction, and joining to one another two other lateral walls of the housing, and the term “vertical” designates the direction which is perpendicular both to the longitudinal direction and the transverse direction, substantially perpendicular to the base wall of said housing.

The present invention can also comprise any one of the following characteristics, taken alone or in combination with one another, provided that they are technically compatible:
the wall of the housing which accommodates the section of the dielectric fluid circuit comprises an inner envelope and an outer envelope delimiting the section; the terms “inner” and “outer” make it possible to define a relative position of each envelope, the inner envelope being towards the interior of the receptacle of the device, and the outer envelope being further to the exterior of the device relative to the inner envelope;
the thermal element is arranged at least partly between the inner envelope and the outer envelope;
the section is delimited by at least one cavity formed between the inner envelope and the outer envelope, the heat exchanger extending at least partly into this cavity;
the section can comprise a plurality of cavities, each of the cavities consisting of an intermediate volume between the inner envelope and the outer envelope;
the cavities which define the section can be formed on a plurality of walls of the housing;
the section of the dielectric fluid circuit formed in the wall comprises at least one distribution channel formed by a first cavity in the wall and opening onto the spraying orifice, and/or it comprises a recuperation cavity;
the recuperation cavity is formed at least partly in the base wall of the device, and is designed to recuperate dielectric fluid which accumulates on this base;
the recuperation cavity is at least partly formed in the lateral wall of the device;
the outer and inner envelopes are mechanically integral with one another, and can be retained for example by adhesion or by welding;
the inner envelope, which advantageously forms the base of the receptacle and/or a lateral wall comprises at least one, and advantageously a plurality of discharge orifices or perforations allowing the dielectric fluid to flow in said recuperation cavity; in other words, said discharge orifice connects the receptacle fluidically to at least one discharge duct; advantageously, the thermal regulation device can comprise a plurality of discharge orifices, said discharge orifices being able for example to have circular or also elongate forms, and be arranged in a series of rows in the base wall and/or at least one lateral wall;
each discharge orifice opens firstly into the receptacle and secondly into the discharge cavity;
the thermal element is arranged in the distribution manifold;
the thermal element is arranged in the recuperation cavity;
the device comprises a base wall extending on a first plane and a plurality of lateral walls extending from the base wall, with the lateral walls extending on planes which intersect the first plane;
the recuperation cavity is advantageously formed in the base wall, between the outer envelope and the inner envelope, with the inner envelope delimiting a base face of the receptacle;
the distribution manifold and/or the recuperation cavity comprise(s) a heat exchanger;
the distribution manifold receives a first thermal element, and the recuperation cavity receives a second thermal element;
the first thermal element has a cooling and/or heating function, and the second thermal element has a cooling and/or heating function, the first and second thermal elements being able to have the same function or a different function;
the first and the second thermal elements are designed to be able to be actuated independently from one another;
the thermal element comprises at least one duct within which a heat-transfer fluid is designed to circulate, the exchanger being designed such as to permit thermal exchange between the heat-transfer fluid in the interior of the duct and the dielectric fluid circulating in the dielectric fluid section on the exterior of the duct.

By way of example, the heat-transfer fluid can be glycolated water, or a cooling fluid of the type R134a, R744 (CO2) or 1234yf. Preferably, the heat-transfer fluid is designed to have a liquid phase in the operating range of the device. It should be noted that, in the present invention, the dielectric fluid circuit and the heat-transfer circuit are advantageously distinct, such that the dielectric fluid which circulates in the dielectric fluid circuit, and the heat-transfer fluid circulating in the heat-transfer fluid circuit are not mixed.
the thermal element comprising an element to provide heat, in particular by Joule effect;
the thermal element is a resistive element which is designed to heat the dielectric fluid circulating in the section;
at least one of the walls of the housing comprises a plurality of spraying orifices, which are advantageously positioned in series, such as to form a row for spraying of the dielectric fluid;
each spraying orifice can be equipped with a dielectric fluid spraying nozzle;
the plurality of spraying orifices can be positioned in a recess of the wall of the housing, such as to form a projection of the wall towards the interior of the housing, and thus towards the interior of the receptacle, said recess being configured to form at least one dielectric fluid distribution manifold. Advantageously, the recess is formed by local deformation of the inner envelope and/or the outer envelope;
the section comprises a supply duct, formed between the inner envelope and the outer envelope, forming the fluidic connection between a dielectric fluid input mouth and the distribution manifold. Advantageously, the supply duct is formed by a local deformation of the inner envelope and/or the outer envelope;
the section comprises a discharge duct forming the fluidic connection between the discharge cavity and an output mouth. Advantageously, the discharge duct is formed by a local deformation of the inner envelope and/or the outer envelope;
the thermal regulation device can comprise a plurality of distribution manifolds, advantageously with at least two distribution manifolds being positioned in opposite lateral walls of the housing, said two distribution manifolds being fluidically connected by the supply duct;
each distribution manifold comprises a spraying row;
a single lateral wall can comprise a plurality of distribution manifolds, said manifolds being by way of example superimposed on one another in a vertical direction which is substantially perpendicular to the base wall and to the main direction of the thermal regulation device;
the supply duct extends in said lateral wall such as to supply with dielectric fluid the plurality of distribution manifolds comprised in this same lateral wall;
the thermal regulation device can be configured to comprise at least one spraying orifice which is positioned in the base wall and is fluidically connected to the supply duct;
alternatively, the thermal element could form directly one of the walls of the section, and the inner envelope and/or the outer envelope, for example the thermal element, takes the form of a cold plate which serves as a cover in the same way as the outer envelope in order to form the cavity with the inner envelope.

According to the invention, “distribution manifold” means a defined circulation volume for the dielectric fluid, which is delimited firstly by the inner envelope and secondly by the outer envelope, and is configured to supply with dielectric fluid at least one spraying orifice. In other words, the distribution manifold is fluidically connected to the at least one supply duct and to the at least one spraying orifice. By way of example, the recess which forms the distribution manifold can be produced by thermoforming or embossing, or it can also be produced by over-molding of an element with the form of an open duct.
the discharge duct consists of a space for circulation of the dielectric fluid, which is delimited firstly by the inner envelope and secondly by the outer envelope; in particular, the supply duct and the discharge duct are distinct;
the thermal regulation device comprises at least one input mouth and/or at least one output mouth for the dielectric fluid in the thermal regulation device; in particular the at least one input mouth is fluidically connected to the supply duct, whereas the at least one output mouth is fluidically connected to the discharge duct;
the device is designed such that the section comprises a supply branch and a discharge branch, the supply branch being the part of the section contained between and comprising the supply mouth and the spraying orifice(s), the discharge branch being the part of the section contained between and comprising the discharge mouth and the discharge orifice(s);
the input mouth is arranged such as to be able to be connected to a dielectric fluid external supply duct, and the output mouth is designed such as to be able to be connected to a dielectric fluid external discharge duct, with “external” meaning outside the device, and being able for example to be a central circuit of a data center, or a motor vehicle circulation loop, the intake and output ducts of a pump, and/or of an expansion vessel;
the input mouth and the output mouth are designed such as to be able to be connected directly to a pump, thus permitting the operation of the device in a closed circuit, this closed circuit also being able to comprise other elements necessary for its satisfactory operation, such as a filter, an expansion vessel, and any other element considered to be necessary by persons skilled in the field;
the housing can be made at least partly or entirely of a composite and heat-resistant plastics material;
the device comprises a plurality of recuperation cavities, each in communication with a discharge duct and a discharge orifice opening onto the receptacle;
the material can consist of a thermoplastic which is consolidated with carbon fibers, glass fibers or aluminum fibers;
the outer envelope can be formed at least partly by a cover;
the cover can be over-molded then welded or secured by means of at least one securing device on the housing;
the cover can comprise or be formed by the thermal element;
the device can also comprise a third thermal element in the form of a condenser, which is advantageously positioned in the high position of the device, such as to condense the dielectric fluid vapor within the receptacle, said condenser being designed to have a heat-transfer fluid passing through it, of the same type as that of the heat-transfer fluid circuit;
the outer envelope can be formed by a plurality of covers which are secured in a sealed manner on the inner envelope;
the dielectric fluid can be selected such as to remain in the liquid phase throughout the entire normal operating range of the device, and thus be known as single-phase dielectric fluid, or it can be selected such as to undergo a phase change between the liquid phase and the gaseous phase in the normal operating range of the device, and thus be known as two-phase dielectric fluid, and advantageously the two-phase dielectric fluid is selected such as to have a phase change temperature at an optimal threshold operating temperature of the electrical and/or electronic element to be thermally treated.

The present invention also relates to a housing of an electrical and/or electronic element, comprising a device as previously described, and at least one, and advantageously a plurality of, electrical and/or electronic elements assembled in the device. “Electrical and/or electronic element” means an electrical energy storage element, for example a battery, a module or a battery cell, which is in particular designed to supply power to an electric vehicle; an electronic power device; a semiconductor element; an element which constitutes a computer server; or any other electronic and/or electrical element which requires thermal regulation during its operation.

The present invention also relates to a thermal regulation system comprising at least the thermal regulation device as previously described, with a dielectric fluid circulating in a dielectric fluid circuit, at least one unit for circulation of the dielectric fluid in the dielectric fluid circuit, and advantageously comprising a heat-transfer fluid circulating in a heat-transfer fluid circuit, and at least one means for circulation of the heat-transfer fluid in the heat-transfer fluid circuit.

Said units and means for circulation, respectively of the dielectric fluid and the heat-transfer fluid, can be pumps. The thermal regulation system comprises at least one plurality of connection channels which are configured to connect the circulation unit to the input mouth and/or the output mouth for the dielectric fluid, or to connect the means for circulation to the heat-transfer fluid circulation duct of the heat exchanger(s), and the system can also comprise means for electrical connection in the case when the thermal element is for example a resistive element.

Other characteristics, details and advantages of the invention will become more clearly apparent, on the one hand on reading the following description, and on the other hand from a number of examples of embodiments that are given by way of non-limiting indication, with reference to the appended schematic drawings, in which:

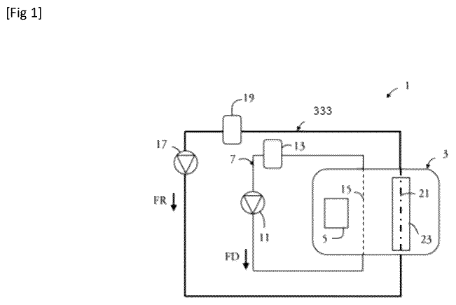

FIG. 1 represents a thermal regulation system comprising at least one regulation device according to the invention;

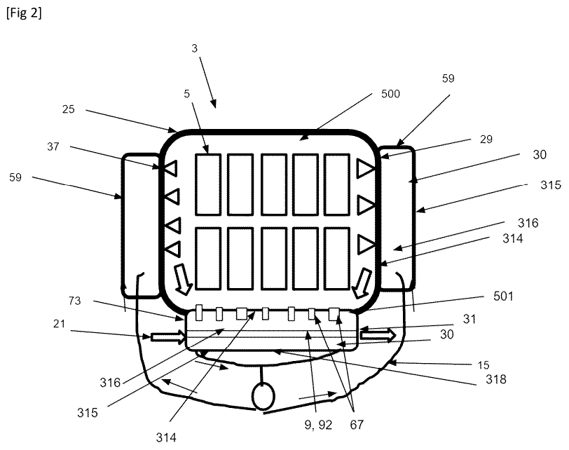

FIG. 2 represents a schematic view of the thermal regulation device according to a first embodiment of the invention;

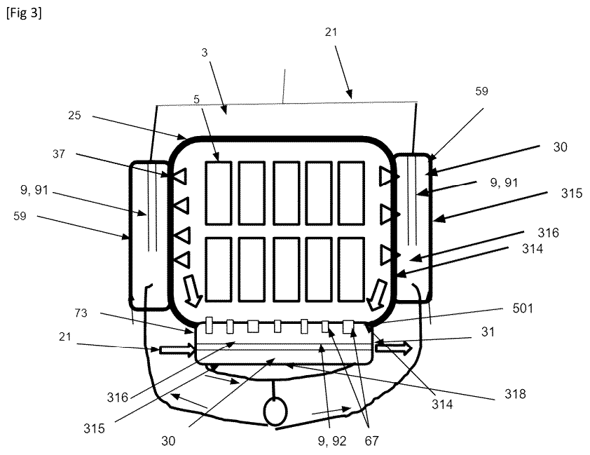

FIG. 3 represents a schematic view of the thermal regulation device according to a second embodiment of the invention;

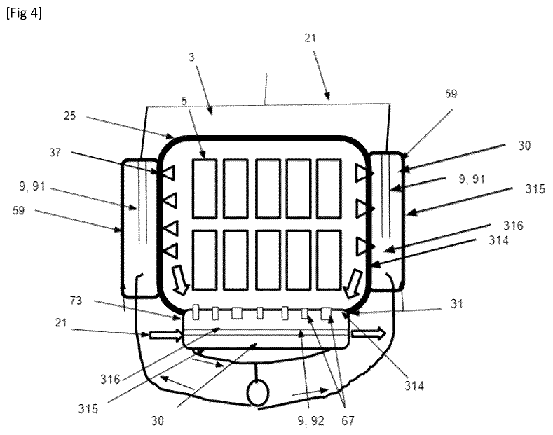

FIG. 4 represents a schematic view of the thermal regulation device according to a third embodiment of the invention;

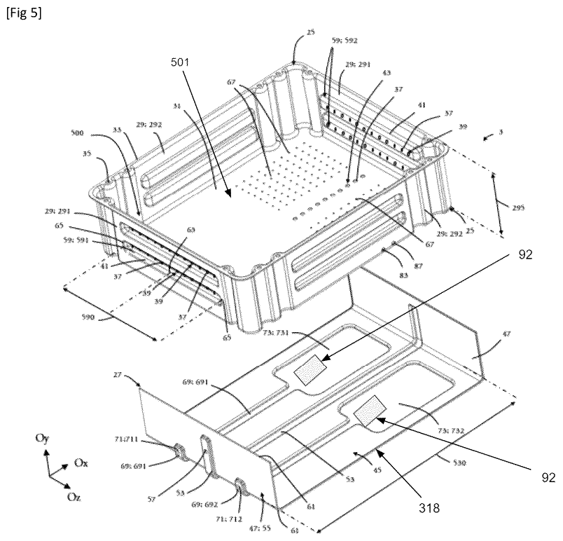

FIG. 5 represents an exploded view in perspective of a housing and a cover of the thermal regulation device as illustrated in one of FIGS. 2 to 4;

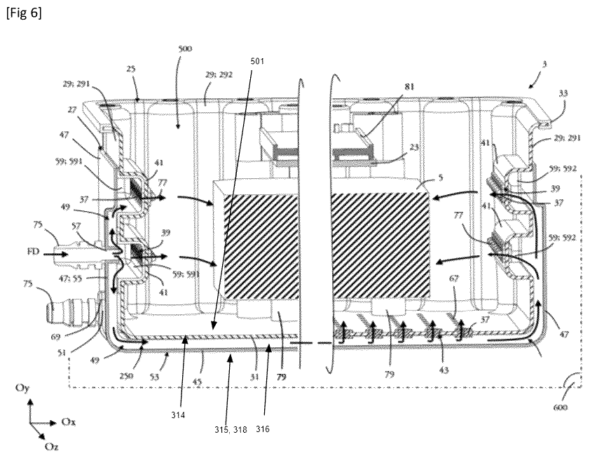

FIG. 6 is a view in cross-section, produced along a first longitudinal plane, of the thermal regulation device as illustrated in one of FIGS. 2 to 4;

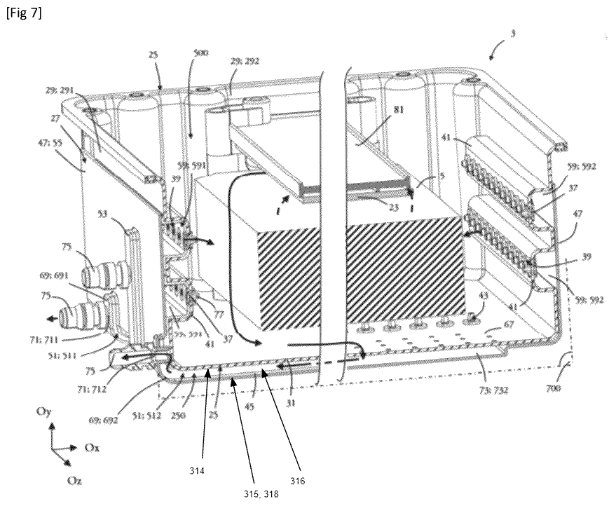

FIG. 7 is a view in cross-section, produced along a second longitudinal plane, of the thermal regulation device as illustrated in one of FIGS. 2 to 4.

It should firstly be noted that the figures show the invention in detail in order to implement the invention, and it will be appreciated that said figures can be used to define the invention better if applicable.

In addition, with reference to the orientations and directions previously defined, the longitudinal direction will be represented by the axis Ox, whereas the axes Oy and Oz will represent respectively the vertical and transverse directions. These axes define together a trihedron xyz represented in the figures which require it. In this reference system, the terms “top” or “upper” will be represented by the positive direction of the axis Oy, and the terms “bottom” or “lower” are represented by the negative direction of this same axis Oy.

FIG. 1 represents schematically a thermal regulation system 1 comprising at least one thermal regulation device 3 associated with an electrical storage device, comprising one or a plurality of electrical or electronic components, the temperature of which must be regulated, for example decreased.

The thermal regulation system 1 comprises a first, dielectric fluid (FD) loop 7 and a second, heat-transfer fluid (FR) loop 333.

The first loop 7 comprises at least one unit 11 for circulation of the dielectric fluid, such as a pump, and can in this case for example comprise a storage tank, or expansion vessel 13 for said fluid. Also, the first loop 7 comprises at least one dielectric fluid circuit 15 permitting the circulation of the dielectric fluid, which in this case is represented schematically by a first broken line, said dielectric fluid circuit 15 being formed at least partly in the thermal regulation device 3.

The second loop comprises at least one means 17 for circulation of the cooling fluid, such as a pump, and at least one tank 19 for storage of said fluid. In addition, the second loop comprises at least one heat-transfer fluid 21, which permits circulation of the heat-transfer fluid, is formed at least partly in the thermal regulation device 3 and is represented by a second broken line. In particular, the heat transfer fluid circuit 21 can extend at least partly into at least one heat exchanger 9, 91, 92, 23.

Within the thermal regulation system 1, the thermal regulation device 3 is thus configured to implement at least one heat exchange between the dielectric fluid circulating in the dielectric fluid circuit 15, and the heat-transfer fluid circulating in the heat-transfer fluid circuit 21, as will be described in greater detail hereinafter.

Reference is made initially to FIGS. 2 to 7, in order to describe the thermal regulation device 3 more particularly.

The thermal regulation device 3 comprises at least one housing 25. The thermal regulation device 3 comprises least the dielectric fluid circuit 15, configured to permit the circulation of a dielectric fluid, and the heat-transfer fluid circuit 21 configured to permit the circulation of a heat-transfer fluid.

The housing 25 comprises a plurality of lateral walls 29 which emerge from a common base wall 31, and extend in the vertical direction Oy defined by a vertical axis 100. It can be made of a composite and heat-resistant plastics material which, by way of example, can be consolidated with carbon fibers or aluminum fibers. The lateral walls 29 and the base wall 31 of the housing 25 thus delimit a receptacle 500 for the thermal regulation device 3, in which there extends at least the electrical component 5, the temperature of which must be regulated.

The housing 25 has a substantially parallelepiped form, and comprises four lateral walls 29, with a main dimension of the housing 25 extending parallel to a longitudinal axis 200 of the longitudinal direction Ox. It is nevertheless understood that the form of the housing 25 is in no way limiting, and that it could for example comprise more lateral walls 29.

The housing 25 comprises a plurality of orifices 37 for spraying of the dielectric fluid. Said spraying orifices 37 consist of through orifices, which in this case are circular, positioned in the lateral walls 29, and/or in the base wall 31. The orifices can comprise spraying nozzles (not represented in this case).

FIGS. 2 to 7 represent schematically a thermal regulation device 3 for at least one electrical and/or electronic component 5, the temperature of which must be regulated, with the thermal regulation device 3 comprising at least one housing 25 comprising a plurality of walls delimiting a receptacle 500 which is designed to receive said electrical and/or electronic component 5, the device 3 also comprising a dielectric fluid circuit 15, which is configured to permit the circulation of a dielectric fluid, and at least one of the walls 29 of the housing 25 comprises at least one orifice 37 for spraying of the dielectric fluid in the receptacle 500, with the spraying orifice 37 fluidically connected to the dielectric fluid circuit, the dielectric fluid circuit 15 comprising a section 30 formed within one of the walls 29, 31 of the housing 25, and the section of the dielectric fluid circuit also receives a thermal element 9, 91, 92, which is designed to exchange heat with the dielectric fluid circulating in the dielectric fluid circuit 15.

The walls 29, 31 of the housing 25 which accommodate the section 30 of the dielectric fluid circuit comprise an inner envelope 314 and an outer envelope 315 delimiting the section. The thermal element 9, 91, 92 is arranged at least partly between the inner envelope 314 and the outer envelope 315.

The section 30 is contained in a cavity 316 delimited by the inner envelope 314 and the outer envelope 315, with the thermal element 9, 91, 92 extending at least partly in this cavity 316.

The recuperation cavity 73 is formed between the outer envelope 315 forming a base face 318 of the device, and the inner envelope 314 forming a base face 501 of the receptacle 500.

The inner envelope 314 is perforated by at least one orifice, and advantageously a plurality of orifices 67 allowing the dielectric fluid to flow into said recuperation cavity 73.

In FIG. 2, the thermal element 92 is arranged in the recuperation cavity 73. The thermal element 92 is a heat exchanger which is designed to have a heat-transfer fluid of the second circuit 21 passing through it.

In FIG. 3, a thermal element 91 is arranged in the distribution manifold 59, and a thermal element 92 is arranged in the recuperation cavity 73. Advantageously, the thermal element 92 is a heat exchanger which is designed to have a heat-transfer fluid passing through it. The thermal element 91 can also be a heat exchanger which is designed to have a heat-transfer fluid passing through it. Alternatively, the first thermal element 91 and/or the second thermal element 92 can be a resistive element.

In FIG. 4, a thermal element is arranged in the distribution manifold 59.

FIGS. 2 to 4 describe 3 different embodiments of a device according to the invention. In fact, these embodiments differ in the location of the thermal element 9.

FIG. 2 shows a first embodiment, in which the thermal element 9 is a heat exchanger 92 with at least one duct in which a heat-transfer fluid coming from the heat-transfer fluid circuit 21 is designed to circulate. The heat exchanger 92 extends in the recuperation cavity 73, and thus makes it possible to cool directly the dielectric fluid coming from the receptacle 500 and recuperated into the recuperation cavity 73 by the discharge orifices or perforations 67.

The discharge orifices 57 are formed in the inner envelope 314 at the base wall 31 of the housing 25. The section 30 of the dielectric fluid circuit formed in the wall comprises at least one distribution manifold 59 formed in the wall and opening onto the spraying orifice 37, and/or it comprises a recuperation cavity 73 positioned in a base wall 31 of the device, and designed to recuperate dielectric fluid which accumulates on this base.

In FIGS. 5 to 7, upper borders 33 of the lateral walls 29 are configured to cooperate with a lid (not represented) which is designed to close the housing on its upper face. The borders comprise, for example, at least one means 35 for securing said cover on the housing 25. By way of example, this lid can consist of a flat element, which is configured to cooperate with the housing 25, or of an element with a form and dimensions similar to those of the housing 25.

In the example illustrated, amongst the lateral walls 29, primary lateral walls 291 are distinguished, which are orthogonal to the longitudinal axis 200 and opposite one another within the housing 25: they comprise a plurality of spraying orifices 37 and secondary lateral walls 292, which are parallel to the longitudinal axis 200 and are without orifices. The spraying orifices 37 are positioned in series in the transverse direction Oz such as to form two spraying rows 39 which are superimposed on one another in the vertical direction, and extend parallel to one another.

Advantageously, the spraying rows 39 are arranged at recesses 41 in the primary lateral walls 291. The recesses 41 can be produced by thermoforming or embossing, and form a substantially parallelepiped structure which extends towards the receptacle 500, with the different spraying orifices 37 which form the spraying rows 39 being positioned at a base of said recesses 41, i.e. at the inner envelope which extends in the interior of the receptacle 500.

Also, according to the example illustrated, and as shown more particularly in FIGS. 5, 6 and 7 in particular, the thermal regulation device 3 comprises at least one additional spraying row 43 provided in the base wall 31. It should be noted that, without departing from the context of the invention, the thermal regulation device 3 can be without said additional spraying row 43 at the base wall 31.

In this embodiment, the outer envelope is formed at least partly by a cover 27 consisting of an added-on part over-molded onto the housing 25. Thus, the cover 27 has a structure which is at least partly complementary to that of the housing 25.

In the example illustrated, the cover 27 has a structure in the form of a “U”. It comprises a base 45 and two lateral panels 47 projecting from said base 45 in a direction which is substantially perpendicular to it. Similarly to the housing 25, the cover 27 can be made of a composite and heat-resistant plastics material, which, for example, can be consolidated with carbon fibers or aluminum fibers.

When it is assembled on the housing 25, the cover 27 can be kept integral with said housing 25 by welding, adhesion, or by means of at least one securing device such as a screw-nut system. The base 45 of the cover 27 thus extends facing the inner envelope 314 at the base wall 31 of the housing 25, whereas the lateral panels 47 of the cover 27 in this case extend facing the inner envelope 314 at the primary lateral walls 291 of said housing 25.

In the present invention, the cover 27 and the housing 25 are configured in particular such as to form a part of the dielectric fluid circuit 15 with a cavity 316 or intermediate volume 250, contained between the inner and outer envelopes, forming at least one space for circulation of the dielectric fluid. This intermediate volume 250 will be described in greater detail hereinafter.

In the thermal regulation device 3 which is illustrated in particular in FIGS. 5 to 7, the dielectric fluid circuit 15 comprises a supply duct 49, which is configured to bring the dielectric fluid to at least one of the spraying orifices 37 for the dielectric fluid, and two discharge ducts 51. It should be noted that the number of supply 49 or discharge 51 ducts is in no way limiting, and can be modified, such that, for example, the thermal regulation device 3 comprises a plurality of supply ducts 49, or, alternatively, such that it comprises a single discharge duct 51.

The section 30 comprises a supply duct 49 formed between the inner envelope 314 and the outer envelope 315, forming the fluidic connection between a dielectric fluid input mouth 57 and the distribution manifold 59.

The section 30 comprises a discharge duct 51 which forms the fluidic connection between the discharge cavity 73 and an output mouth 71.

The supply duct 49 is formed between the inner envelope and the outer envelope. The outer envelope, formed in this embodiment by the cover 27, comprises at least one trough, known as the primary trough 53, which participates in forming said supply duct 49.

The primary trough 53 consists of an indentation formed in the cover 27, by embossing or thermoforming for example, which is configured to direct and limit the circulation of the dielectric fluid in the housing 25 of the thermal regulation device 3. The primary trough 53 illustrated extends along a longitudinal length 530 of the base 45 of the cover 27, in the longitudinal direction Ox, and partly in the lateral panels 47 of the cover 27, parallel to the vertical axis 100, such that, when the cover 27 and the inner envelope are assembled, the supply duct 49 extends along the primary lateral walls 291 and the base wall 31 of the housing.

At one of its lateral panels 47, which is known hereinafter as the first lateral panel 55, the cover 27 comprises at least one mouth 57 for input of the dielectric fluid, which mouth is fluidically connected to the supply duct 49 formed between the cover 27 and the housing 25. Thus, the dielectric fluid is brought into the thermal regulation device 3 by the input mouth 57 positioned projecting from the cover 27, and can then circulate in the supply duct 49.

The supply duct 49 extends in the thermal regulation device 3, such as to connect the input mouth 57 fluidically to at least one of the spraying orifices 37 for the dielectric fluid, for the purpose of spraying of the dielectric fluid in the receptacle 500, in particular on the electrical component 5.

In particular, the primary trough 53 is positioned such as to extend at least partly facing at least one of the recesses 41 of the inner envelope 314 comprising at least one of the spraying rows 39.

In particular, when the inner envelope 314 and the outer envelope 315 are assembled, each of the recesses 41 forms a manifold 59 for distribution of the dielectric fluid to a plurality of spraying orifices 37, for example one or a plurality of spraying rows 39, i.e. the recesses 41 form volumes for circulation and distribution of the dielectric fluid, such as to supply to the spraying orifices 37 which can be arranged spaced from the supply duct 49.

Advantageously, the thermal regulation device 3 can thus comprise one or a plurality of distribution manifolds 59 in each of its opposite primary lateral walls 291. In the example illustrated, each of the primary lateral walls 291 comprises two distribution manifolds 59, each accommodating a spraying row 39 of spraying orifices 37.

The perforation 67 is positioned in the inner envelope 314 at the base wall 31 of the housing 25, and assures the fluidic connection between the receptacle 500, delimited by the walls 29, 31 of the housing 25, and the cavity 316 at the base wall, which extends between the inner envelope 314 and the outer envelope 315. Advantageously, the thermal regulation device 3 comprises a plurality of perforations 67.

In the example illustrated in FIGS. 5 to 7, the base wall 31 comprises two sub-assemblies of perforations 67 positioned on both sides of the additional spraying row 43, said perforations 67 being in particular positioned such as to be fluidically connected to at least one of the discharge ducts 51.

According to an alternative not represented, at least one of the discharge ducts 51 can be fluidically connected to a plurality of recuperation cavities 73.

It is understood from reading the foregoing that the present invention proposes a thermal regulation system comprising at least one device for thermal regulation of at least one electrical component, such as an electrical storage device. The thermal regulation device according to the present invention thus advantageously makes it possible to simplify the complete thermal control system, and in particular the circulation and spraying of the dielectric fluid onto at least one electrical component accommodated within the thermal regulation device.

However, the invention is by no means limited to the means and configurations described and illustrated herein, and it also extends to any equivalent means or configuration and to any technically operational combination of such means. In particular, the location of the spraying rows, their number, as well as the number of spraying orifices or their form, can be modified without detracting from the invention, provided that the thermal regulation device ultimately fulfils the same functionalities as those described in the present document.

1. A thermal regulation device for at least one electrical or electronic component, the thermal regulation device comprising:
at least one housing,
wherein the housing comprises a plurality of walls delimiting a receptacle,
wherein the receptacle is designed to receive the electrical or electronic component; and
a dielectric fluid circuit which is configured to permit the circulation of a dielectric fluid,
wherein at least one of the walls of the housing comprises at least one orifice for spraying of dielectric fluid in the receptacle,
wherein the spraying orifice is fluidically connected to the dielectric fluid circuit,
wherein the circuit comprises a section formed within one of the walls of the housing,
wherein the section also contains a thermal element, and
wherein the thermal element is configured to exchange heat with the dielectric fluid circulating in the dielectric fluid circuit.

2. The device as claimed in claim 1,
wherein the wall of the housing which accommodates the section of the dielectric fluid circuit comprises an inner envelope and an outer envelope,
wherein the section is delimited by the inner and outer envelopes,
wherein the thermal element is arranged at least partly between the inner envelope and the outer envelope.

3. The device as claimed in claim 1,
wherein the section of the dielectric fluid circuit comprises at least one distribution manifold formed in the wall and opening onto the spraying orifice, and/or
wherein the section of the dielectric fluid circuit further comprises a recuperation cavity positioned in a base wall of the device, and designed to recuperate dielectric fluid which accumulates in this base.

4. The device as claimed in claim 3,
wherein the thermal element is arranged in the distribution manifold or in the recuperation cavity.

5. The device as claimed in claim 2,
wherein the recuperation cavity is formed between the outer envelope which forms a base face of the device, and the inner envelope which forms a base face of the receptacle.

6. The device as claimed in claim 2,
wherein the inner envelope is perforated by at least one orifice to allow the dielectric fluid to flow into the recuperation cavity.

7. The device as claimed in claim 2,
wherein the section comprises a supply duct, formed between the inner envelope and the outer envelope, forming the fluidic connection between a dielectric fluid input mouth and the distribution manifold, and
wherein the section also comprises a discharge duct forming the fluidic connection between the discharge cavity and an output mouth.

8. The device as claimed in claim 1,
wherein each spraying orifice comprises a nozzle for spraying of the dielectric fluid.

9. A housing for an electrical and/or electronic element,
comprising a device as claimed in claim 1, and at least one of electrical or electronic elements assembled in the device.

10. A thermal regulation system comprising:
a thermal regulation device as claimed in claim 1;
a dielectric fluid circulating in a dielectric fluid circuit; and
at least one unit for circulation of the dielectric fluid in the dielectric fluid circuit.
